(19) United States
(12) Patent Application Publication
(10) Pub. No.: US 2021/0118235 A1
(43) Pub. Date: Apr. 22, 2021

(54) METHOD AND APPARATUS FOR PRESENTING AUGMENTED REALITY DATA, ELECTRONIC DEVICE AND STORAGE MEDIUM

(71) Applicant: BEIJING SENSETIME TECHNOLOGY DEVELOPMENT CO., LTD., Beijing (CN)

(72) Inventors: Xinru HOU, Beijing (CN); Shengchuan SHI, Beijing (CN); Guoxiong LI, Beijing (CN)

(21) Appl. No.: 17/134,772

(22) Filed: Dec. 28, 2020

Related U.S. Application Data
(63) Continuation of application No. PCT/CN2020/111888, filed on Aug. 27, 2020.

(30) Foreign Application Priority Data
Oct. 15, 2019 (CN) 201910979912.0

(51) Int. Cl. G06T 19/00; G06F 3/01

(52) U.S. Cl. CPC G06T 19/006; G06F 3/011

(57) ABSTRACT

Provided are a method and apparatus for presenting an Augmented Reality (AR) data, an electronic device and a storage medium. The method includes that: data of a reality scene is acquired; attribute information of a target physical object in the data of the reality scene is recognized, and special effect data, matched with the attribute information, of a virtual object is determined; and AR data including the special effect data of the virtual object is presented in an AR device based on the special effect data of the virtual object.

### CROSS-REFERENCE TO RELATED APPLICATION

The present application is a continuation of International Patent Application No. PCT/CN2020/111888, filed on Aug. 27, 2020, that is based upon and claims priority to Chinese Patent Application No. 201910979912.0, filed on Oct. 15, 2019. The disclosures of International Patent Application No. PCT/CN2020/111888 and Chinese Patent Application No. 201910979912.0 are hereby incorporated by reference in their entireties.

### BACKGROUND

AR technology can fuse physical information (visual information, sound, touch and the like) subjected to simulation with a real world, thereby presenting a real environment and a virtual object in the same picture or space in real time. It is more and more important to optimize an effect of an AR scene presented by an AR device and improve the interactivity with a user.

### SUMMARY

The disclosure relates to the technical field of Augmented Reality (AR), and particularly to a method and apparatus for presenting AR data, an electronic device and a storage medium.

According to a first aspect, the embodiments of the disclosure provide a method for presenting AR data, which may include:

data of a reality scene is acquired;

attribute information of a target physical object in the data of the reality scene is recognized, and special effect data, matched with the attribute information, of a virtual object, is determined; and

AR data including the special effect data of the virtual object is presented in an AR device based on the special effect data of the virtual object.

According to a second aspect, the embodiments of the disclosure provide an apparatus for presenting AR data, which may include an acquisition portion, a recognition portion and a presentation portion.

The acquisition portion may be configured to acquire data of a reality scene and transmit the data of the reality scene to the recognition portion.

The recognition portion may be configured to recognize attribute information of a target physical object in the data of the reality scene, determine special effect data, matched with the attribute information, of a virtual object and transmit the special effect data of the virtual object to the presentation portion.

The presentation portion may be configured to present AR data including the special effect data of the virtual object in an AR device based on the special effect data of the virtual object.

According to a third aspect, the embodiments of the disclosure provide an electronic device, which may include a processor, a memory and a bus. The memory may store a machine-readable instruction executable by the processor. When the electronic device runs, the processor may communicate with the memory through the bus. The machine-readable instruction may be executed by the processor to implement the steps of the method for presenting AR data as described in the first aspect or any implementation mode.

According to a fourth aspect, the embodiments of the disclosure provide a computer-readable storage medium, in which a computer program may be stored. The computer program may be executed by a processor to implement the steps of the method for presenting AR data as described in the first aspect or any implementation mode.

Descriptions about effects of the apparatus for presenting AR data, the electronic device and the computer-readable storage medium refer to the descriptions about the method for presenting AR data, and elaborations are omitted herein.

In order to make the purpose, characteristics and advantages of the embodiments of the disclosure clearer and easier to understand, detailed descriptions will be made below with the preferred embodiments in combination with the drawings.

### BRIEF DESCRIPTION OF THE DRAWINGS

For describing the technical solutions of the embodiments of the disclosure more clearly, the drawings required to be used in the embodiments will be simply introduced below. The drawings, which are incorporated in and constitute a part of this specification, illustrate embodiments satisfying the disclosure and, together with the specification, serve to explain the technical solutions of the embodiments of the disclosure. It is to be understood that the following drawings only illustrate some embodiments of the disclosure and thus should not be considered as limits to the scope. Those of ordinary skill in the art may also obtain other related drawings according to these drawings without creative work.

FIG. 1 is a flowchart of a method for presenting AR data according to an embodiment of the disclosure.

FIG. 2 is a possible schematic diagram of acquiring an image of a reality scene according to an embodiment of the disclosure.

FIG. 3 is a possible image obtained after superimposition of an image of a virtual body to a reality scene according to an embodiment of the disclosure.

FIG. 4 is a possible schematic diagram of presenting attribute information of a virtual body according to an embodiment of the disclosure.

FIG. 5A is a schematic diagram of special effect data of a virtual body, i.e., a state presented by the virtual body, before a pose of a reference physical object is recognized according to an embodiment of the disclosure.

FIG. 5B is a schematic diagram of special effect data of a virtual body, i.e., a state presented by the virtual body, after a pose of a reference physical object is recognized according to an embodiment of the disclosure.

FIG. 6 is a schematic diagram of presenting an AR image including indication data of a navigation route in an AR device according to an embodiment of the disclosure.

FIG. 7 is a structure diagram of an apparatus for presenting AR data according to an embodiment of the disclosure.

FIG. 8 is a structure diagram of an electronic device according to an embodiment of the disclosure.

### DETAILED DESCRIPTION

In order to make the purpose, technical solutions and advantages of the embodiments of the disclosure clearer, the technical solutions in the embodiments of the disclosure will be clearly and completely described below in combination with the drawings in the embodiments of the disclosure. It is apparent that the described embodiments are not all embodiments but only part of embodiments of the disclosure. Components, described and shown in the drawings, of the embodiments of the disclosure may usually be arranged and designed with various configurations. Therefore, the following detailed descriptions about the embodiments of the disclosure provided in the drawings are not intended to limit the claimed scope of the embodiments of the disclosure but only represent selected embodiments of the disclosure. All other embodiments obtained by those skilled in the art based the embodiments of the disclosure without creative work shall fall within the scope of protection of the embodiments of the disclosure.

The embodiments of the disclosure may be applied to an electronic device (for example, an AR device like a mobile phone, a tablet computer and AR glasses) or server supporting an AR technology or a combination thereof. Under the condition that the embodiments of the disclosure are applied to a server, the server may be connected with another electronic device with a communication function and a photographic function, a connection manner may be wired connection or wireless connection, and wireless connection may be, for example, Bluetooth connection and Wireless Fidelity (WIFI) connection.

Presenting an AR scene in an AR device may be understood as presenting a virtual object fused with a reality scene in the AR device. A presented picture of the virtual object may be directly rendered for fusion with the reality scene. For example, a virtual tea set may be presented as being placed on a real tabletop in a reality scene. Or, after a presented special effect of the virtual object and an image of the reality scene are fused, a fused picture is presented. The specific presentation manner to be selected may be determined by the type of the AR device and a picture presentation technology that is adopted. For example, under a normal condition, a reality scene (not an image of the reality scene) may be directly seen from AR glasses, so that the AR glasses can adopt a presentation manner of directly rendering a presented picture of a virtual object. For a mobile terminal device such as a mobile phone or a tablet computer, a picture formed after a reality scene is imaged is presented in the mobile terminal device, so that the manner of fusing an image of a reality scene with a presented special effect of a virtual object may be adopted to present an AR effect.

A fusion degree of a virtual object in a reality scene greatly influences a presentation effect of the virtual object. Presenting matched virtual objects based on different attributes of a target physical object in a reality scene may ensure that presentation of the virtual object meets a requirement on the reality scene better, thereby achieving higher fusion performance and further improving a presentation effect of an AR scene.

A method for presenting AR data involved in the embodiments of the disclosure will be introduced below in detail.

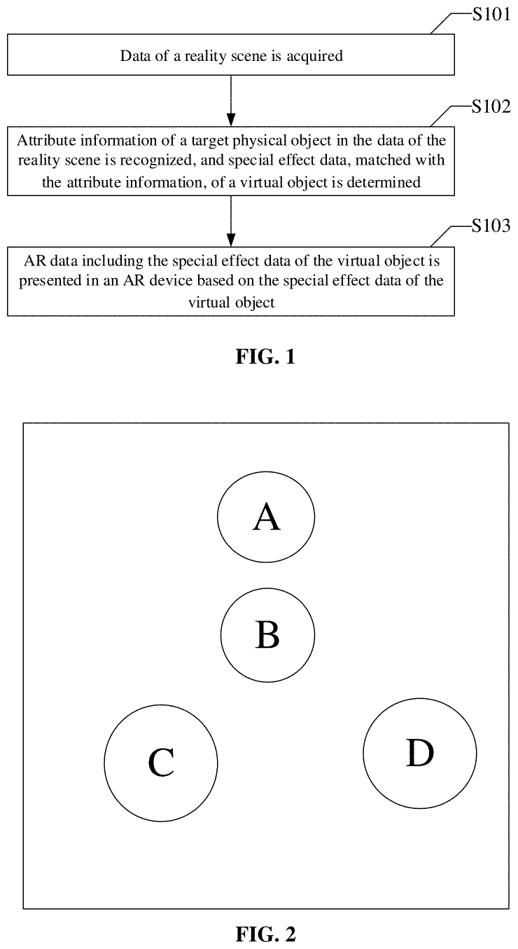

Referring to FIG. 1, a flowchart of a method for presenting AR data according to an embodiment of the disclosure is shown. The following steps are included.

In S101, data of a reality scene is acquired.

In S102, attribute information of a target physical object in the data of the reality scene is recognized, and special effect data, matched with the attribute information, of a virtual object is determined.

In S103, AR data including the special effect data of the virtual object is presented in an AR device based on the special effect data of the virtual object.

Through the method, special effect data of a virtual object required to be presented, for example, a commodity pattern, a descriptive content of a remaining item and a building name, may be determined based on recognized related attribute information of the target physical object in the data of the reality scene, for example, the type of the object (for example, a counter), the state of the object (for example, information of the remaining item in the counter) and the name of the object (for example, a building name). Then, AR data including the special effect data of the virtual object may be presented in the AR device to satisfy a present reality scene and enrich a presentation effect.

The steps will be described respectively blow.

In S101, the data of the reality scene may include, but not limited to, at least one of an image of the reality scene, a reality scene sound and the like.

It is to be noted here that, under the condition that the data of the reality scene includes an image of the reality scene, the image of the reality scene may be acquired and the attribute information of the target physical object therein may be recognized to determine the special effect data of the matched virtual object. The image of the reality scene may be configured to subsequently generate AR data, or may be not configured to subsequently generate AR data. As described above, a presented picture of the virtual object may be directly rendered for fusion with the reality scene, or the image of the reality scene may be fused with the special effect data of the virtual object for rendering.

Different types of data of a reality scene include different types of target physical objects. For example, under the condition that the data of the reality scene includes the image of the reality scene, physical objects in the data of the reality scene may include a building, a placed item and the like, and the physical objects in the data of the reality scene may also include a special sound effect, a special smell effect and the like.

Under the condition that the data of the reality scene includes the image of the reality scene, the image of the reality scene may be acquired in a manner of, for example, acquiring through a built-in camera (for example, a front camera) of the AR device or acquiring through a camera deployed in the reality scene and independent of the AR device, or may also be acquired through user image data transmitted to the AR device through another device. An acquisition manner for the image of the reality scene is not limited in the disclosure.

In S102, the attribute information of the target physical object may be, for example, a class of the target physical object, a size of the target physical object or the name of the target physical object, etc.

In a possible implementation mode, a manner that may be adopted to recognize the attribute information of the target physical object in the data of the reality scene may include: the image of the reality scene including the target physical object is input to a pre-trained recognition model, and the image of the reality scene is processed through the recognition model to output the attribute information of the target physical object.

In another possible implementation, the attribute information of the target physical object in the data of the reality scene may also be recognized in the following manner: setting different auxiliary identifiers on different physical objects, for example, adding different two-dimensional codes to the physical objects and scanning the two-dimensional code on the target physical object, thereby obtaining the attribute information of the target physical object.

In S102, the image of the reality scene may include one or more physical objects. When there are multiple physical objects, the multiple physical objects may be determined as target physical objects and subjected to attribute information recognition. For saving processing resources, reducing unnecessary recognition and accurately recognizing a viewing requirement of a user, the target physical object satisfying a matching condition may be selected based on pose data of the AR device, and then the attribute information can be recognized. The pose data may include position information and/or shooting orientation of the AR device in the reality scene. There may be the following conditions for selecting the target physical object based on the pose data of the AR device.

A first condition: the pose data includes the position information.

Under this condition, a distance between a position of each physical object presented in an image of a reality scene in the reality scene and a position of the AR device in the reality scene may be calculated, and when the calculated distance is shorter than a preset distance, the physical object is determined as a target physical object.

Exemplarily, as shown in FIG. 2 which is a possible schematic diagram of acquiring an image of a reality scene. In the figure, the position at point A is position information of the AR device in the reality scene, and B, C and D are position information of physical objects in the image of the reality scene to be shot by the AR device in the reality scene respectively. When a distance between B and A is shorter than the preset distance, A is determined as a target physical object.

In another possible implementation mode, the distance between the position of each physical object presented in the image of the reality scene in the reality scene and the position information of the AR device in the reality scene may also be calculated, and the physical object corresponding to the calculated shortest distance is determined as a target physical object.

A second condition: the pose data includes the shooting orientation.

Under the condition that the pose data includes the shooting orientation, a preset shooting orientation corresponding to each physical object may be determined at first. For each physical object, whether the shooting orientation of the AR device overlaps the preset shooting orientation corresponding to the physical object or not is determined, and if YES, the physical object is determined as a target physical object.

Exemplarily, different portraits may be arranged at different heights of the same wall, the physical objects may be the portraits at different heights, and each portrait may have a preset shooting orientation. For example, a preset shooting orientation of portrait A is 30 to 60°, and when the shooting orientation of the AR device is 40°, the portrait A is determined as a target physical object.

During a practical application, when preset shooting orientations of multiple physical objects overlap the shooting orientation of the AR device, the multiple physical objects may be determined as target physical objects, or the physical object corresponding to a largest overlapping orientation may be determined as a target physical object.

A third condition: the pose data includes the position information and the shooting orientation.

Under the condition that the pose data includes both the position information and the shooting orientation, physical objects to be confirmed in a preset distance range away from the position of the AR device may be selected from each physical object, and a physical object corresponding to a preset shooting orientation overlapping the shooting orientation of the AR device in the physical objects to be confirmed is determined as a target physical object.

Following the above example, distances between different portraits arranged at different heights of the same wall and the position of the AR device are the same, and the physical objects to be confirmed are the portraits on the walls. In such case, the target physical object may be selected based on the preset shooting orientations of different portraits.

After the attribute information of the target physical object is recognized, the special effect data, matched with the attribute information, of the virtual object may be determined in a special effect database of virtual objects. Exemplarily, when the attribute information of the target physical object is a beverage showcase, the special effect data of the virtual object may include a beverage image, and may also include descriptive information of the beverage image, such as a beverage name. When the attribute information of the target physical object is a bookcase, the special effect data of the virtual object may be a book image, and may also include descriptive information of the book image, such as a book title and an author.

In the embodiments of the disclosure, after the attribute information of the target physical object is recognized, the presented special effect data of the virtual object may be independently set by users. When different users set different special effect data of virtual objects to be presented, under the condition that the attribute information of the target physical object is detected in terminal devices of the different users, attribute information of different target physical objects may be presented on the devices of the different users.

In the embodiments of the disclosure, special effect data of a virtual object may be selectively configured for a physical object in the reality scene. For example, no special effect data of related virtual objects is configured for some physical objects. Under this condition, after attribute information of some target physical objects is recognized, special effect data of corresponding virtual objects may be null.

In the above description, the determined special effect data, matched with the attribute information of the target physical object, of the virtual object may be special effect data, matched with the pose data of the AR device, of the virtual object determined from the special effect data of the virtual object in the special effect database of virtual objects. In a possible implementation mode, the special effect data of the virtual object may be determined based on the pose data of the AR device in the reality scene and pose data (which may be considered to be stored in the special effect database of virtual objects) of the virtual object in a three-dimensional scene model configured to represent the reality scene.

Here, for facilitating development of special effect data of virtual objects, a three-dimensional scene model may be adopted to describe a reality scene, and the special effect data of the virtual objects may be developed based on the three-dimensional scene model, so that the special effect data of the virtual objects may be fused with the reality scene better. In this way, special effect data of a virtual object may be determined based on pose data (including position information and/or a shooting orientation) of an AR device in a reality scene and pose data of the virtual object in the three-dimensional scene model configured to represent the reality scene.

In some embodiments of the disclosure, for conveniently rendering special effect data of a virtual object and recovering a presented special effect of the virtual object in a three-dimensional scene model, transparency processing may be performed on the three-dimensional scene model in a presented picture including the presented special effect of the virtual object and the three-dimensional scene model. In such a manner, in a subsequent rendering stage, the presented picture including the presented special effect of the virtual object and the three-dimensional scene model subjected to transparency processing may be rendered, so that a reality scene corresponds to the three-dimensional scene model. Therefore, the presented special effect of the virtual object in the three-dimensional scene model may be obtained in a real world.

In the above-described contents, under the condition that the virtual object is static, the pose data of the virtual object in the three-dimensional scene model may include position information (for example, geographical position coordinate information) and/or corresponding pose information (presented pose of the virtual object) of the virtual object in the three-dimensional model. Under the condition that the virtual object is dynamic, the pose data of the virtual object in the three-dimensional scene model may include multiple sets of position information (for example, geographical position coordinate information) and/or corresponding pose information (presented poses of the virtual object).

During specific implementation, after the pose data of the AR device in the reality scene is determined, the special effect data, matched with the pose data of the AR device, of the virtual object may be determined from the pose data of the virtual object in the three-dimensional scene model. For example, a position and pose, etc., matched with a present position and shooting orientation of the AR device, of the virtual object may be determined from special effect data of the virtual object in a constructed building model scene.

Before attribute information recognition is performed on each physical object in the image of the reality scene in S102, or before the target physical object satisfying the matching condition is selected based on the pose data of the AR device and the attribute information of the target physical object is recognized, the physical objects that may be independently segmented in the image of the reality scene may be determined at first. In a possible implementation mode, each physical object in the image of the reality scene may be determined through the following process: performing image segmentation on the image of the reality scene, and then recognizing a physical object corresponding to each portion of segmented image obtained by image segmentation. Image segmentation aims to segment the image into a plurality of specific regions with peculiar properties and extract an interested target.

For the operation in S103 that the AR data including the special effect data of the virtual object is presented in the AR device, based on different types of AR devices and different types of special effect data of virtual objects, each type of special effect data may be presented respectively, or, multiple types of special effect data are combined for presented.

1) Under the condition that the virtual object includes a sound, presenting the AR data including the special effect data of the virtual object may refer to playing a sound corresponding to the attribute information of the target physical object in an electronic device shooting the reality scene.

For example, the attribute information of the target physical object may be a coffeemaker of a certain size, and under the condition that a coffeemaker of the size is detected in the data of the reality scene, it may be determined that the special effect data, matched with the attribute information, of the virtual object is a certain segment of sound record of introducing coffee. In such case, the segment of sound record may be played in the AR device.

2) Under the condition that the virtual object includes a smell, the attribute information of the target physical object in the data of the reality scene may be recognized, a smell type and smell release time length matched with the attribute information are determined, the determined smell type and smell release time length are sent to a third-party device that controls smell release, and the third-party device that controls smell release is instructed to release a corresponding type of smell for the time length.

3) Under the condition that the virtual object includes a presented picture of a virtual body, the presented picture may be static or dynamic, and the AR data may include an AR image. Based on different types of AR devices, different presentation methods may correspondingly be adopted for the AR image.

A possible presentation method may be applied to AR glasses. Specifically, a virtual body may be presented in lenses of the AR glasses based on preset position information of the virtual body in a reality scene, and under the condition that a user views the reality scene through the lenses, where the virtual body is presented, of the AR glasses, the virtual body may be viewed at the corresponding position of the virtual body in the reality scene.

Another possible presentation method may be applied to an electronic device such as a mobile phone and a pad. Under the condition that AR data including special effect data of a virtual object is presented, the AR device may generate an image of a reality scene based on the reality scene, and the AR data presented on the AR device may be an image obtained after superimposition of an image of the virtual body to the image of the reality scene.

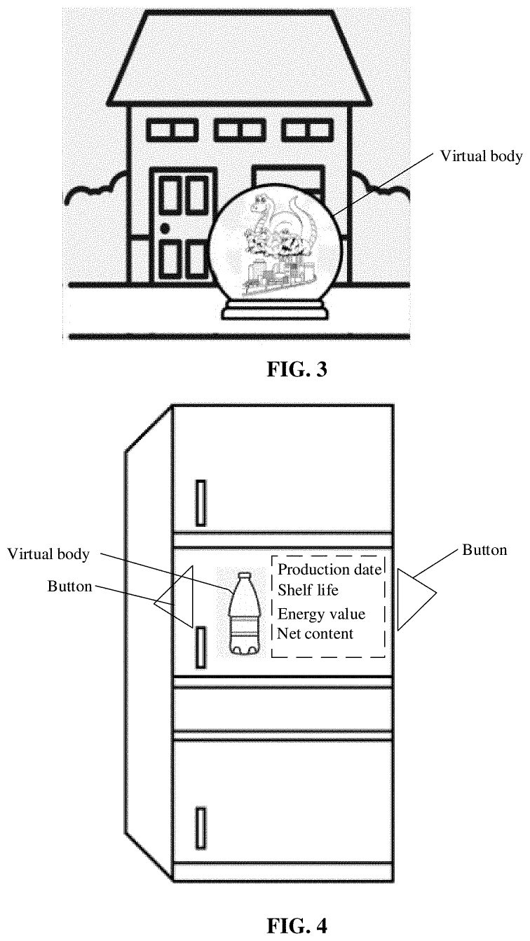

Exemplarily, the AR image that may be presented in the abovementioned presentation manner may be shown in FIG. 3. There may be an occlusion relationship between the superimposed image of the virtual body and a physical object in the reality scene. Specific introductions will be made below, and descriptions are omitted herein.

In another example, in a process of presenting the AR image including the virtual body, attribute information of the virtual body may also be presented. Herein, both the virtual body and the attribute information belong to the special effect data of the virtual object. As shown in FIG. 4, the target physical object is a refrigerator with a transparent door, the virtual body is a beverage in the refrigerator (beverages in the refrigerator are preset), and the attribute information of the virtual object is the production date, shelf life, energy value, net content and the like of the beverage. Under the condition that the target physical object is a bookcase, the virtual body may be a book placed on the bookcase, and the attribute information of the virtual object is the author, press, publication date and the like of the book.

For enhancing reality experiences, an interaction effect between the virtual object and the reality scene may be added in the presented AR scene. For example, responsive to a pose of a shot reference physical object, special effect data, matched with the pose of the reference physical object, of the virtual object may be presented.

Specifically, the pose of the shot reference physical object may be recognized, then the special effect data, matched with the pose of the reference physical object, of the virtual object is acquired, and AR data presently presented in the AR device is updated with first target AR data, the first target AR data including the special effect data, matched with the pose of the reference physical object, of the virtual object.

Here, the reference physical object refers to any physical object capable of presenting a reference pose in the reality scene, and for example, may be a user operating the AR device or a person or animal or robot in the reality scene.

Under a possible condition, the pose of the reference physical object may include at least one of a facial expression and a body movement. When the pose of the reference physical object is recognized, pose recognition processing may be performed on an acquired image of the reality scene based on a pre-trained neural network model to obtain the pose of the reference physical object presented in the acquired image of the reality scene.

Under a possible condition, the operation that the pose of the shot reference physical object is recognized may be implemented in the following manner: a distance between the position information of the AR device in the reality scene and corresponding position information of the virtual object in the reality scene is detected; and under the condition that the distance is in a preset distance range, the pose of the shot reference physical object is recognized.

Specifically, an acquired image of the reality scene may be input to the pre-trained neural network model, and the neural network model may output the pose recognized from the acquired image of the reality scene and determine the recognized pose as the pose of the reference physical object.

A training sample for training a neural network may be a sample image with a pose label. For example, the pose label may be a facial expression label (for example, the facial expression may be smiling, laughing, crying or doubting) and/or a body movement label (for example, the body movement may be photographing, handshaking or greeting). A predicted pose of each sample image may be obtained based on the neural network model, and the neural network may be trained based on the predicted pose and pose label of the sample image. Introductions about a specific training process are omitted.

Updating the AR data presently presented in the AR device with the first target AR data may refer to updating the special effect data of the virtual object in the AR data to present a new presented state of the virtual object presently presented in the AR device.

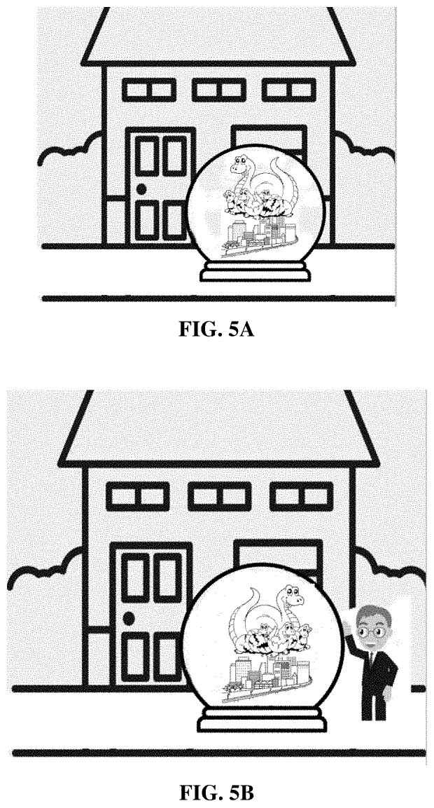

Exemplarily, in a scenario that the reference physical object is another user cooperating with the user operating the AR device in the reality scene, a gesture, expression and/or body movement of the other user can be acquired through the AR device, and then the virtual object can be controlled to present a state corresponding to the gesture, expression and/or body movement of the other user. Here, recognizable gestures, expressions and/or body movements, etc., of the user may be preset, and states of the virtual object corresponding to each gesture, expression and/or body movement may also be preset. For example, special effect data of the virtual object, i.e., a state presented by the virtual body, before the pose of the reference physical object is recognized, may be shown in FIG. 5A. A state presented by the virtual body when the pose of the reference physical object in the image of the reality scene is detected may be shown in FIG. 5A. The state presented by the virtual body after the pose for photographing is recognized is presented in FIG. 5B.

In another scenario, the reference physical object may be the user operating the AR device, namely the user operating the AR device may make a related gesture on the virtual object based on the presently presented AR scene. In such case, the gesture of the user of the AR device may be recognized, and a corresponding operation may be executed. Exemplarily, following the example shown in FIG. 4, whether the two arrows beside the beverage in the reality scene are clicked or not is recognized, thereby determining whether to modify the presently displayed beverage and the attribute information thereof or not; or whether the beverage in the reality scene is clicked or not is recognized to determine whether the beverage is bought or not. When it is recognized that the beverage is clicked, a corresponding payment interface may be presented in the AR device. After successful payment is detected, order information is generated, and the order information is then sent to a corresponding merchant server, thereby implementing purchase of a physical body based on the virtual body.

In another possible implementation mode, a response may be given to a triggering operation acting on the AR device, then special effect data, matched with the triggering operation, of the virtual object is acquired, and the AR data presently presented in the AR device is updated with second target AR data. The second target AR data includes the special effect data, matched with the triggering operation, of the virtual object.

The triggering operation may include at least one of: an operation (for example, click, double click, long press or slide) on a screen of the AR device, sound inputting or changing of a pose of the AR device (for example, changing of the position of the AR device or changing of the shooting orientation of the AR device).

Exemplarily, following the example shown in FIG. 4, under the condition that the attribute information of the beverage is presented in the AR device, whether the two virtual buttons beside the beverage in the AR scene are clicked or not may be detected, and in addition, whether a triggering operation is executed at positions corresponding to the two virtual buttons on the screen of the AR device or not may be determined. An effect corresponding to the triggering operation corresponds to a gesture operation detected in the reality scene. For example, a click operation over the arrow beside the beverage on the screen of the AR device and triggering of the arrow beside the beverage based on a gesture in the reality scene may be matched with the same special effect data of the virtual object.

During specific implementation, under the condition that the AR data including the special effect data of the virtual object is presented in the AR device, the data of the reality scene includes the image of the reality scene, and the virtual object includes the virtual body, an occlusion relationship between each physical object in the image of the reality scene and the virtual body may be additionally determined. Specifically, the occlusion relationship between each physical object and the virtual object may be determined based on pose information of each physical object, pose information of the virtual body and the pose information of the AR device.

In the embodiments of the disclosure, a navigation effect may be additionally presented.

Specifically, responsive to a navigation request, present position information of the AR device in the reality scene and corresponding position information of the virtual object in the reality scene are acquired, then a navigation route is generated based on the present position information and the corresponding position information of the virtual object in the reality scene, points on the navigation route including a position of the virtual object in the reality scene or including a position region where the virtual object is located in the reality scene, and AR data including indication data of the navigation route may be presented based on the AR device.

The AR device may locally execute a process of generating the navigation route. Or, the navigation request may be sent to a server, and the server may execute the navigation request and send the navigation route to the AR device.

In the embodiments of the disclosure, the navigation effect is added. Under the condition that a user has a navigation requirement, a navigation route added with a position of a virtual object as a passing-by point may be generated based on the navigation requirement. In a possible implementation mode, whether destination information is received or not may be detected. A destination may be any place in the reality scene or may also be a position region where the virtual object is located in the reality scene. Under the condition that a place corresponding to the detected destination information is in a range of the position region where the virtual object is located in the reality scene, a shortest running route for reaching the virtual object may be determined directly based on the present position information of the AR device and the destination information. Under the condition that the destination is a place in the reality scene, a shortest route taking the destination as a navigation end point and passing by the position region where the virtual object is located in the reality scene may be generated, namely the user can be guided to pass by the position region where the virtual object is deployed, so that running experiences and running interestingness of the user in a travel are improved.

In addition, under the condition that the destination information is not received, related introduction information of the virtual object may also be actively pushed. When it is detected that the user clicks a presentation triggering button of the virtual object, the navigation route for reaching the position of the virtual object may be determined and presented on the AR device.

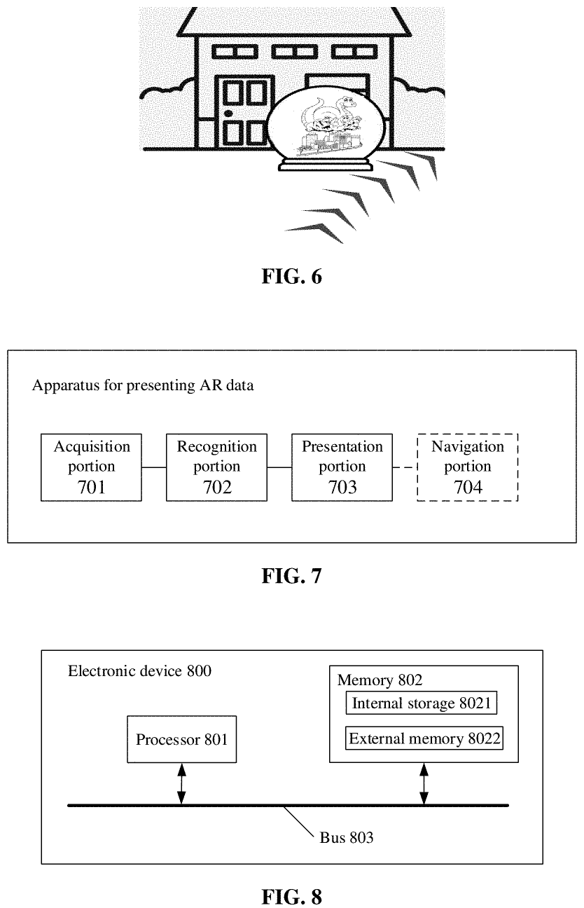

Exemplarily, when an AR image including indication data of a navigation route is presented in an AR device, as shown in FIG. 6, the AR image includes a virtual body and may also include an indication sign (for example, the arrow on the ground), and the indication sign may be presented to guide a user to reach a corresponding position.

Exemplarily, when the user reaches a certain target virtual object, a navigation route reaching another target virtual object associated with the target virtual object may be pushed to the user.

It can be understood by those skilled in the art that, in the method of the specific implementation modes, the sequence of each step does not mean a strict execution sequence and is not intended to form any limit to the implementation process and a specific execution sequence of each step should be determined by functions and probable internal logic thereof.

Based on the same concept, the embodiments of the disclosure provide an apparatus for presenting AR data. Referring to FIG. 7, a structure diagram of an apparatus for presenting AR data according to an embodiment of the disclosure is shown. An acquisition portion 701, a recognition portion 702, a presentation portion 703 and a navigation portion 704 are included, specifically as follows.

The acquisition portion 701 is configured to acquire data of a reality scene and transmit the data of the reality scene to the recognition portion 702.

The recognition portion 702 is configured to recognize attribute information of a target physical object in the data of the reality scene, determine special effect data, matched with the attribute information, of a virtual object and transmit the special effect data of the virtual object to the presentation portion 703.

The presentation portion 703 is configured to present AR data including the special effect data of the virtual object in an AR device based on the special effect data of the virtual object.

In an optional implementation mode, the data of the reality scene may include an image of the reality scene.

The recognition portion 702 is further configured to, before recognizing the attribute information of the target physical object in the data of the reality scene, detect pose data of the AR device in the reality scene, the pose data including position information and/or shooting orientation of the AR device in the reality scene, and determine the target physical object matched with the pose data in at least one physical object presented in the image of the reality scene.

In an optional implementation mode, the presentation portion 703 is further configured to:

recognize a pose of a shot reference physical object;

acquire special effect data, matched with the pose of the shot reference physical object, of the virtual object; and

update AR data presently presented in the AR device with first target AR data, the first target AR data including the special effect data, matched with the pose of the reference physical object, of the virtual object.

In an optional implementation mode, the pose of the shot reference physical object may include at least one of a facial expression and a body movement.

In an optional implementation mode, the presentation portion 703 is further configured to:

detect a distance between the position information of the AR device in the reality scene and corresponding position information of the virtual object in the reality scene; and

when the distance is in a preset distance range, recognize the pose of the shot reference physical object.

In an optional implementation mode, the presentation portion 703 is further configured to:

perform pose recognition processing on an acquired image of the reality scene based on a pre-trained neural network model to obtain the pose of the reference physical object presented in the acquired image of the reality scene.

In an optional implementation mode, the presentation portion 703 is further configured to:

give a response to a triggering operation acting on the AR device;

acquire special effect data, matched with the triggering operation, of the virtual object; and

update the AR data presently presented in the AR device with second target AR data, the second target AR data including the special effect data, matched with the triggering operation, of the virtual object.

In an optional implementation mode, the triggering operation may include at least one of: an operation acting on a screen of the AR device, sound inputting or changing of a pose of the AR device.

In an optional implementation mode, the apparatus may further include a navigation portion 704. The navigation portion 704 is configured to:

responsive to a navigation request, acquire present position information of the AR device in the reality scene and corresponding position information of the virtual object in the reality scene;

generate a navigation route based on the present position information and the corresponding position information of the virtual object in the reality scene, points on the navigation route including a position of the virtual object in the reality scene; and

present AR data including indication data of the navigation route in the AR device.

In an optional implementation mode, the recognition portion 702 is further configured to:

acquire the pose data of the AR device in the reality scene; and

determine the special effect data, matched with the attribute information, of the virtual object based on the pose data of the AR device in the reality scene and pose data of the virtual object in a three-dimensional scene model configured to represent the reality scene.

In some embodiments, functions or templates of the apparatus provided in the embodiment of the disclosure may be configured to execute the method described in the method embodiment and specific implementation thereof may refer to the descriptions about the method embodiment and, for simplicity, will not be elaborated herein.

In the embodiment of the disclosure and other embodiments, “part” may be part of a circuit, part of a processor, part of a program or software and the like, of course, may also be a unit, and may also be modular and non-modular.

Based on the same technical concept, the embodiments of the disclosure also provide an electronic device. Referring to FIG. 8, a structure diagram of an electronic device according to an embodiment of the disclosure is shown. A processor 801, a memory 802 and a bus 803 are included. The memory 802 is configured to store an executable instruction, and includes an internal storage 8021 and an external memory 8022. Here, the internal storage 8021, also called an internal memory, is configured to temporarily store arithmetic data in the processor 801 and data exchanged with the external memory 8022 such as a hard disk. The processor 801 performs data exchange with the external memory 8022 through the internal storage 8021. Under the condition that the electronic device 800 runs, the processor 801 communicates with the memory 802 through the bus 803 such that the processor 801 executes the following instructions of:

acquiring data of a reality scene;

recognizing attribute information of a target physical object in the data of the reality scene and determining special effect data, matched with the attribute information, of a virtual object; and

presenting AR data including the special effect data of the virtual object in an AR device based on the special effect data of the virtual object.

A specific processing process executed by the processor 801 may refer to the descriptions in the method embodiments or the apparatus embodiments, and will not be described herein.

In addition, the embodiments of the disclosure also provide a computer-readable storage medium, in which a computer program is stored. The computer program may be operated by a processor to execute the steps of the method for presenting AR data as described in the method embodiments.

A computer program product for a method for presenting AR data provided in the embodiments of the disclosure includes a computer-readable storage medium storing a program code, and an instruction in the program code may be configured to execute the steps of the method for presenting AR data in the method embodiments, specifically referring to the method embodiments.

Elaborations are omitted herein.

It can be clearly learned by those skilled in the art that specific working processes of the system and device described above may refer to the corresponding processes in the method embodiments and will not be elaborated herein for convenient and brief description. In some embodiments provided by the disclosure, it is to be understood that the disclosed system, device and method may be implemented in another manner. The device embodiments described above are only schematic. For example, division of the units is only logic function division, and other division manners may be adopted during practical implementation. For another example, multiple units or components may be combined or integrated into another system, or some characteristics may be neglected or not executed. In addition, coupling or direct coupling or communication connection between each displayed or discussed component may be indirect coupling or communication connection, implemented through some communication interfaces, of the device or the units, and may be electrical and mechanical or adopt other forms.

The units described as separate parts may or may not be physically separated, and parts displayed as units may or may not be physical units, and namely may be located in the same place, or may also be distributed to multiple network units. Part or all of the units may be selected to achieve the purpose of the solutions of the embodiments according to a practical requirement.

In addition, each functional unit in each embodiment of the disclosure may be integrated into a processing unit, each unit may also physically exist independently, or two or more than two units may also be integrated into a unit.

When realized in form of software functional units and sold or used as an independent product, the function may also be stored in a non-volatile computer-readable storage medium executable by the processor. Based on such an understanding, the technical solutions of the embodiments of the disclosure substantially or parts making contributions to the conventional art or part of the technical solutions may be embodied in form of software product, and the computer software product is stored in a storage medium, including a plurality of instructions configured to enable a computer device (which may be a personal computer, a server, a network device or the like) to execute all or part of the steps of the method in each embodiment of the disclosure. The storage medium includes: various media capable of storing program codes such as a U disk, a mobile hard disk, a Read-Only Memory (ROM), a Random Access Memory (RAM), a magnetic disk or an optical disk.

The above are only the specific implementation modes of the embodiments of the disclosure and not intended to limit the scope of protection of the embodiments of the disclosure. Any variations or replacements apparent to those skilled in the art within the technical scope disclosed by the embodiments of the disclosure shall fall within the scope of protection of the embodiments of the disclosure. Therefore, the scope of protection of the embodiments of the disclosure shall be subject to the scope of protection of the claims.

### INDUSTRIAL APPLICABILITY

The embodiments of the disclosure provide a method and apparatus for presenting AR data, an electronic device and a storage medium. The method includes that: data of a reality scene is acquired; attribute information of a target physical object in the data of the reality scene is recognized, and special effect data, matched with the attribute information, of a virtual object is determined; and AR data including the special effect data of the virtual object is presented in an AR device based on the special effect data of the virtual object. Through the method, special effect data of virtual objects may be determined based on recognized different attribute information of the target physical object in the data of the reality scene, and the special effect data of the virtual object fused to a reality scene may be presented in the AR device, so that presentation of the virtual object may be matched with the attribute information of target physical data in the data of the reality scene, and a presentation effect of an AR scene is improved.

1. A method for presenting augmented reality (AR) data, comprising:
acquiring data of a reality scene;
recognizing attribute information of a target physical object in the data of the reality scene, and determining special effect data, matched with the attribute information, of a virtual object; and
presenting AR data comprising the special effect data of the virtual object in an AR device based on the special effect data of the virtual object.

2. The method of claim 1, wherein the data of the reality scene comprises an image of the reality scene; and
before recognizing the attribute information of the target physical object in the data of the reality scene, the method further comprises:
detecting pose data of the AR device in the reality scene, the pose data comprising position information and/or shooting orientation of the AR device in the reality scene, and
determining the target physical object matched with the pose data from at least one physical object presented in the image of the reality scene.

3. The method of claim 1, further comprising:
recognizing a pose of a shot reference physical object;
acquiring special effect data, matched with the pose of the shot reference physical object, of the virtual object; and
updating AR data presently presented in the AR device with first target AR data, the first target AR data comprising the special effect data, matched with the pose of the shot reference physical object, of the virtual object.

4. The method of claim 3, wherein the pose of the shot reference physical object comprises at least one of a facial expression and a body movement.

5. The method of claim 3, wherein recognizing the pose of the shot reference physical object comprises:
detecting a distance between position information of the AR device in the reality scene and corresponding position information of the virtual object in the reality scene; and
when the distance is in a preset distance range, recognizing the pose of the shot reference physical object.

6. The method of claim 3, wherein recognizing the pose of the shot reference physical object comprises:
performing pose recognition processing on an acquired image of the reality scene based on a pre-trained neural network model to obtain the pose of the shot reference physical object presented in the acquired image of the reality scene.

7. The method of claim 1, further comprising:
giving a response to a triggering operation acting on the AR device;
acquiring special effect data, matched with the triggering operation, of the virtual object; and
updating the AR data presently presented in the AR device with second target AR data, the second target AR data comprising the special effect data, matched with the triggering operation, of the virtual object.

8. The method of claim 7, wherein the triggering operation comprises at least one of: an operation acting on a screen of the AR device, sound inputting, and changing of a pose of the AR device.

9. The method of claim 1, further comprising:
responsive to a navigation request, acquiring present position information of the AR device in the reality scene and corresponding position information of the virtual object in the reality scene;
generating a navigation route based on the present position information and the corresponding position information of the virtual object in the reality scene, wherein points on the navigation route comprise a position of the virtual object in the reality scene; and
presenting AR data comprising indication data of the navigation route in the AR device.

10. The method of claim 1, wherein determining the special effect data, matched with the attribute information, of the virtual object comprises:
acquiring pose data of the AR device in the reality scene; and
determining the special effect data, matched with the attribute information, of the virtual object based on the pose data of the AR device in the reality scene and pose data of the virtual object in a three-dimensional scene model configured to represent the reality scene.

11. An electronic device, comprising: a processor and a memory capable of communicating with the processor,
wherein the processor is configured to execute instructions stored in the memory to cause the electronic device to perform operations comprising:
acquiring data of a reality scene and transmit the data of the reality scene to a recognition portion;
recognizing attribute information of a target physical object in the data of the reality scene, determining special effect data, matched with the attribute information, of a virtual object and transmitting the special effect data of the virtual object to a presentation portion; and
presenting AR data comprising the special effect data of the virtual object in an AR device based on the special effect data of the virtual object.

12. The electronic device of claim 11, wherein the data of the reality scene comprises an image of the reality scene; and the processor is further configured to:
before recognizing the attribute information of the target physical object in the data of the reality scene, detect pose data of the AR device in the reality scene, the pose data comprising at least one of position information or shooting orientation of the AR device in the reality scene, and
determine the target physical object matched with the pose data from at least one physical object presented in the image of the reality scene.

13. The electronic device of claim 11, wherein the processor is further configured to:
recognize a pose of a shot reference physical object;
acquire special effect data, matched with the pose of the shot reference physical object, of the virtual object; and
update AR data presently presented in the AR device with first target AR data, the first target AR data comprising the special effect data, matched with the pose of the shot reference physical object, of the virtual object.

14. The electronic device of claim 13, wherein the pose of the shot reference physical object comprises at least one of a facial expression or a body movement.

15. The electronic device of claim 13, wherein the processor is further configured to:
detect a distance between position information of the AR device in the reality scene and corresponding position information of the virtual object in the reality scene; and when the distance is in a preset distance range, recognize the pose of the shot reference physical object; or
perform pose recognition processing on an acquired image of the reality scene based on a pre-trained neural network model to obtain the pose of the shot reference physical object presented in the acquired image of the reality scene.

16. The electronic device of claim 11, wherein the processor is further configured to:
give a response to a triggering operation acting on the AR device;
acquire special effect data, matched with the triggering operation, of the virtual object; and
update the AR data presently presented in the AR device to second target AR data, the second target AR data comprising the special effect data, matched with the triggering operation, of the virtual object.

17. The electronic device of claim 16, wherein the triggering operation comprises at least one of: an operation acting on a screen of the AR device, sound inputting, or changing of a pose of the AR device.

18. The electronic device of claim 11, wherein the processor is further configured to:
responsive to a navigation request, acquire present position information of the AR device in the reality scene and corresponding position information of the virtual object in the reality scene;
generate a navigation route based on the present position information and the corresponding position information of the virtual object in the reality scene, wherein points on the navigation route comprise a position of the virtual object in the reality scene; and
present AR data comprising indication data of the navigation route in the AR device.

19. The electronic device of claim 11, wherein the processor is further configured to:
acquire pose data of the AR device in the reality scene; and
determine the special effect data, matched with the attribute information, of the virtual object based on the pose data of the AR device in the reality scene and pose data of the virtual object in a three-dimensional scene model configured to represent the reality scene.

20. A non-transitory computer-readable storage medium, storing a computer program that, when executed by a processor, implements operations comprising:
acquiring data of a reality scene;
recognizing attribute information of a target physical object in the data of the reality scene, and determining special effect data, matched with the attribute information, of a virtual object; and
presenting AR data comprising the special effect data of the virtual object in an AR device based on the special effect data of the virtual object.
